(19) United States
(12) Patent Application Publication
(10) Pub. No.: US 2014/0005855 A1
(43) Pub. Date: Jan. 2, 2014

(54) DEVICE AND METHOD FOR CALCULATING A REMAINING MILEAGE OF AN ELECTRIC VEHICLE

(71) Applicants: Zhihao Hu, Wuhan (CN); Falong Li, Shanghai (CN)

(72) Inventors: Zhihao Hu, Wuhan (CN); Falong Li, Shanghai (CN)

(73) Assignee: O2MICRO INC., Santa Clara, CA (US)

(21) Appl. No.: 13/552,796

(22) Filed: Jul. 19, 2012

(30) Foreign Application Priority Data
Jun. 29, 2012 (CN) 201210222436.6

(51) Int. Cl. G06F 7/00

(52) U.S. Cl. 701/1

(57) ABSTRACT

A device for calculating mileage is disclosed. The device includes an estimation calculator, a mileage calculator, and a filter. The estimation calculator is configured for determining a first battery power consumed over a first predetermined distance, wherein the first battery power is determined based on a velocity and an initial remaining power. The mileage calculator is coupled to the estimation calculator, and is configured for determining an estimated remaining mileage based on the first battery power, the first predetermined distance, and a power balance. A filter is coupled to the estimation calculator and the mileage calculator, and is configured for smoothing the estimated remaining mileage and outputting a smoothed estimated remaining mileage.

### CROSS-REFERENCE TO RELATED APPLICATIONS

The present application claims the benefit of priority to Chinese Patent Application Serial No. 201210222436.6 filed Jun. 29, 2012, which is incorporated herein by reference in its entirety.

### BACKGROUND

Electric vehicles, including electric cars and electric motorcycles are becoming more common due to their environmental and economical advantages. Usually, an electric vehicle is powered by an internal electric vehicle battery (EVB) that includes a lead-acid battery, nickel-metal hydride battery and/or lithium-ion battery. However, a user of electric vehicles can only obtain state of charge (SOC) information of the internal EVB in the form of a percentage. It is therefore difficult to determine the remaining mileage for any electric vehicle.

### SUMMARY

In an embodiment, a device for calculating mileage is disclosed. The device may comprise an estimation calculator, a mileage calculator, and a filter. The estimation calculator is configured for determining a first battery power consumed over a first predetermined distance, wherein the first battery power is determined based on a velocity and an initial remaining battery power. The mileage calculator, coupled to the estimation calculator, is configured for determining an estimated remaining mileage based on the first battery power, the first predetermined distance, and a power balance. The filter, coupled to the estimation calculator and the mileage calculator, is configured for smoothing the estimated remaining mileage and outputting a smoothed estimated remaining mileage.

In an embodiment, an electric controller is disclosed. The electric controller may comprise a sensor, a battery gauge, a mileage device, and a display unit. The sensor is configured for obtaining a velocity. The battery gauge is configured for obtaining an initial remaining battery power. The mileage device is configured for determining a remaining mileage based on the velocity and the initial remaining battery power. The display unit is configured for displaying the remaining mileage.

In an embodiment, a method for calculating remaining mileage is disclosed. An estimation calculator calculates a first battery power consumed over a first predetermined distance, wherein the first battery power is determined based on a velocity and a remaining battery power. A mileage calculator calculates an estimated remaining mileage based on the first battery power, the first predetermined distance and a power balance. A filter smoothes the estimated remaining mileage and outputs a smoothed estimated remaining mileage.

### BRIEF DESCRIPTION OF THE DRAWINGS

Features and advantages of the claimed subject matter will be apparent from the following detailed description of embodiments consistent therewith, where the description should be considered with reference to the accompanying drawings.

FIG. 1 illustrates a diagram of an electric vehicle controller, in accordance with an embodiment of the present disclosure.

FIG. 2 illustrates a diagram of a mileage device, in accordance with an embodiment of the present disclosure.

FIG. 3 illustrates a flowchart of a process for calculating remaining mileage of an electric vehicle, in accordance with an embodiment of the present disclosure.

FIG. 4 illustrates a flowchart of a method for calculating remaining mileage of an electric vehicle, in accordance with an embodiment of the present disclosure.

### DETAILED DESCRIPTION

In accordance with an embodiment of the present disclosure, a mileage device configured to calculate a remaining mileage of an electric vehicle is disclosed. The mileage device is configured to calculate a remaining mileage based on velocity information and battery power information of an electric vehicle. The mileage device is further configured to recalculate the remaining mileage at intervals such as every time the electric vehicle has been driven a predetermined distance. Consequently, the remaining mileage of the electric vehicle can be provided to anyone using the electric vehicle.

Reference will now be made in detail to the embodiments described in the present disclosure. While certain embodiments of the present disclosure are described, it is understood that the present disclosure is not intended to be limited to these embodiments. The present disclosure is also intended to cover alternatives, modifications and equivalents, which may be included within the spirit and scope of any of the embodiments described herein.

Furthermore, in the following detailed description of the present disclosure, numerous specific details are set forth in order to provide a thorough understanding of the embodiments described herein. However, it will be recognized by one of ordinary skill in the art that the embodiments described herein may be practiced without these specific details.

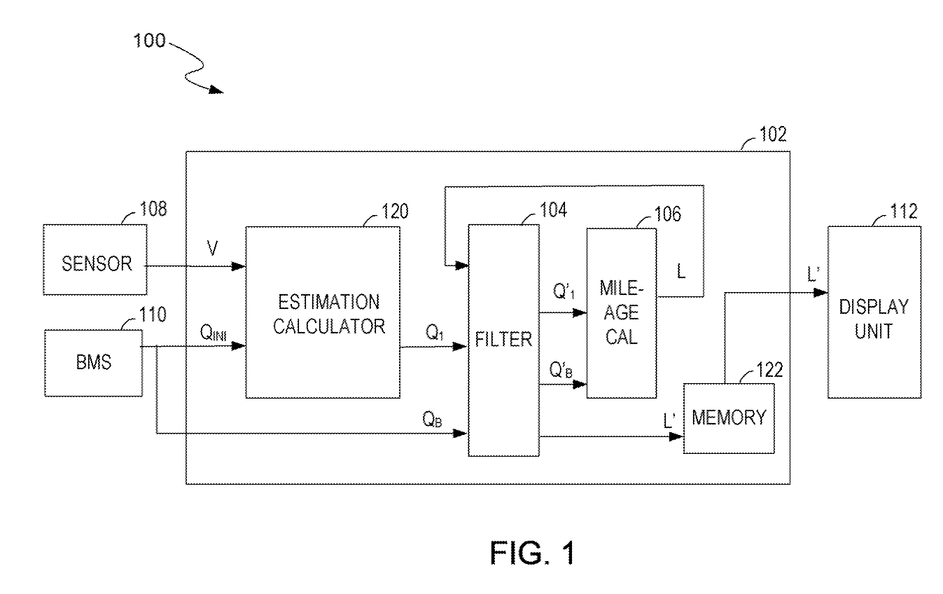

FIG. 1 illustrates a diagram of an electric vehicle controller 100, in accordance with an embodiment of the present disclosure. The electric vehicle controller 100 includes a sensor 108, a battery management system (BMS) 110, a mileage device 102 and a display unit 112. The sensor 108 provides velocity information V of an electric vehicle and the BMS 110, which may include a battery gauge, provides initial remaining battery power information Q_{INI} of the electric vehicle. The initial remaining battery power Q_{INI} represents the instantaneous battery power of the EVB at an initial time when a round of remaining mileage calculation begins. The remaining mileage may be calculated at periodic intervals or rounds based on a predetermined distances traveled by the electric vehicle.

The mileage device 102 is coupled to sensor 108 and BMS 110. Mileage device 102 is configured to receive the velocity V from sensor 108 and the initial remaining battery power Q_{INI} from BMS 110. Mileage device 102 generates a remaining mileage L′ of the electric vehicle. The mileage device 102 may also include an estimation calculator 120, a filter 104, a mileage calculator 106 and a memory 122. The estimation calculator 120 calculates a battery power Q₁ which represents the battery power which the electric vehicle has consumed while driving a first predetermined distance D, e.g. 100 km, under the velocity V. The battery power Q₁ can be calculated based on the velocity V and the initial remaining battery power Q_{INI}. The battery power Q₁ may also be calculated based on the velocity V and ΔQ, where ΔQ=Q₂=Q_{B}−Q_{INI}. Q₂ represents a battery power and Q_{B} represents a power balance, which is the current instantaneous battery power after travelling a second predetermined distance. The second predetermined distance may occur at a time before the first predetermined distance has been traveled, and furthermore, the second predetermined distance may have the same value or different value from the first predetermined distance. Further description of a calculation process utilized by estimation calculator 120 is described below.

The filter 104 receives and smoothes a signal representing the battery power Q₁ and outputs a filtered battery power Q′₁ to the mileage calculator 106. Upon receiving the filtered battery power Q′₁, the mileage calculator 106 analyzes the filtered battery power Q′₁ and informs the filter 104 to achieve a power balance Q_{B1} of the electric vehicle by instructing the BMS 110 to output a power balance Q_{B}. The filter 104 smoothes the power balance Q_{B} received from BMS 110 and outputs a filtered or smoothed power balance Q′_{B} to the mileage calculator 106.

In an embodiment, the filter 104 is a first order filter using a first order filter algorithm equation (1) represented as follows:

Y(n)=aX(nX1−a)Y(n−1) (1)

where a represents a filter coefficient, X(n) represents a sample value of a round of calculation, Y(n) represents the filtered output of the round, and Y(n−1) represents the filtered output last round. By employing the first order filter algorithm, the filter 104 can generate a smoother output by weighting the sample value of a current round and the filtered output of the last round. In an embodiment, the mileage device 102 recalculates the remaining mileage each time a vehicle has been driven a second predetermined distance, e.g., 100 m. Thus, the mileage device 102 and the filter 104 can operate and utilize multiple calculation rounds to update the remaining mileage.

The filter 104 employs equation (1) to smooth the battery power Q₁ and the power balance Q_{B}. More specifically, a given calculation round's filtered battery power Q′₁ can be calculated using the calculation round's battery power Q₁ obtained from the estimation calculator 120 and the last calculation round's filtered battery power Q′₁ by equation (1). Similarly, the current calculation round's filtered power balance Q′_{B} can be calculated using the calculation round's power balance Q_{B} obtained from the BMS 110 and the last calculation round's filtered power balance Q′_{B} by equation (1).

The mileage calculator 106 then generates an estimated remaining mileage L based on the filtered battery power Q′₁, the filtered power balance Q′_{B} and the first predetermined distance D. The estimated remaining mileage L can be calculated based on equation (2) as follows:

$$L = \frac{Q \text{?}}{Q \text{?}} \text{?} {D}^{L = \frac{{Q}_{B 1}^{′}}{{Q}_{1}^{′}} \text{?} D} \\ \text{?} \text{indicates text missing or illegible when filed} \qquad ( 2 )$$

The estimated remaining mileage L is output back to filter 104. The filter 104 may then filter and smooth the estimated remaining mileage L and output the remaining mileage L′ of the electric vehicle. In an embodiment, the remaining mileage L′ may also be calculated by filter 104 using equation (1). More specifically, a calculation round's remaining mileage L′ can be calculated using the calculation round's estimated remaining mileage L obtained from the mileage calculator 106 and the last calculation round's remaining mileage L′.

The memory 122 is configured to store the remaining mileage L′ output by filter 104. As described above, the remaining mileage is recalculated each time after the electric vehicle has traveled or been driven a second predetermined distance. More specifically, after the electric vehicle has traveled or been driven a second predetermined distance, the mileage device 102 starts a new calculation round and generates a new remaining mileage L′. The memory 122 is updated with the new remaining mileage accordingly.

The display unit 112 is configured to display the remaining mileage. In an embodiment, the display unit 112 accesses and reads the memory 122 to retrieve the remaining mileage periodically and then update and/or display the remaining mileage at a predetermined frequency, e.g., every second.

Advantageously, the mileage device 102 may calculate the remaining mileage of the electric vehicle based upon a current driving velocity and battery power information of the electric vehicle. Meanwhile, since the mileage device 102 calculates the remaining mileage periodically, the remaining mileage can be updated in real-time, to provide a driver or user of an electric vehicle constant updates with regard to remaining mileage on their electric vehicle.

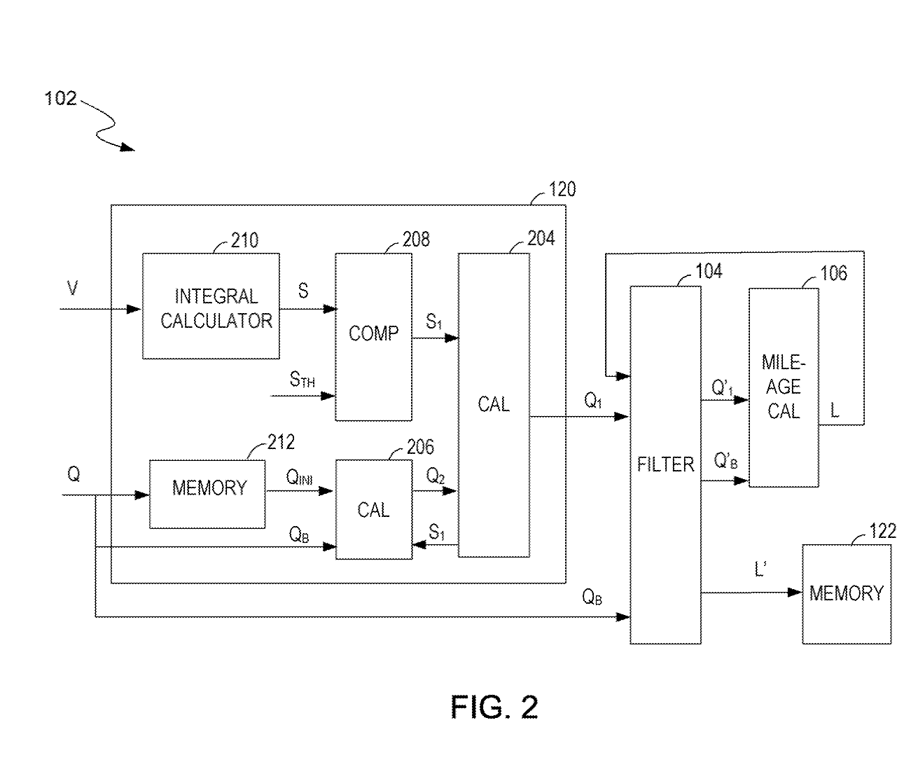

FIG. 2 illustrates a diagram of the mileage device 102 in the FIG. 1, in accordance with an embodiment of the present disclosure. FIG. 2 is described with respect to elements and reference numerals used in FIG. 1 and discussed above. Elements that are labeled the same as in FIG. 1 have similar functions and have been described above with respect to FIG. 1 and are applicable to FIG. 2. The estimation calculator 120 may include an integral calculator 210, a comparator 208, a first calculator 204, a second calculator 206 and a memory 212.

The integral calculator 210 receives the velocity V from sensor 108 and calculates a current driving distance S of the electric vehicle based on the velocity V. The current driving distance S can be calculated based on equation (3) as follows:

S=∫vdt (3)

The comparator 208 periodically compares the current driving distance S with a distance threshold S_{TH}, e.g., 100 m. When the current driving distance S is detected to be greater than the distance threshold S_{TH}, the compactor 208 outputs a first distance S₁ that equals the current driving distance S. The first calculator 204 receives the first distance S₁ and a battery power Q₂ representing the power the electric vehicle has consumed while traveling or being driven the first distance S₁ and uses this data to calculate the battery power Q₁. The battery power Q₁ can be calculated based on equation (4) as follows:

$${ }^{Q 1 = \frac{S 1}{D} \text{?} Q 2} {Q}_{1} = \frac{\text{?}}{\text{?}} \text{?} {Q}_{2} \\ \text{?} \text{indicates text missing or illegible when filed} \qquad ( 4 )$$

where D represents the aforementioned first predetermined distance.

The filter 104 then smoothes the estimated remaining mileage L and outputs the remaining mileage L′ of the electric vehicle. In an embodiment, the remaining mileage L′ may be calculated by filter 104 using equation (1). More specifically, a calculation round's remaining mileage L′ can be calculated using the calculation round's estimated remaining mileage L obtained from the mileage calculator 106 and based on the last calculation round's remaining mileage L′. The memory 122 is configured to store the remaining mileage L′. As described above, the remaining mileage is recalculated each time the electric vehicle has traveled or been driven a second predetermined distance. More specifically, after the electric vehicle has traveled or been driven a second predetermined distance, the mileage device 102 starts a new calculation round and generates a new remaining mileage L′. The memory 122 is updated with the most current remaining mileage accordingly.

The second calculator 206 is configured to provide the battery power Q₂ based on the initial remaining battery power information Q_{INI} and a power balance Q_{B} of the electric vehicle. Second calculator 206 provides battery power Q₂ after the first calculator 204 receives the first distance S₁ when first calculator 204 thereafter informs the second calculator 206 to calculate the battery power Q₂. The battery power Q₂ can be calculated based on the difference between the initial remaining battery power information Q_{INI} and the power balance Q. In an embodiment, memory 212 stores the initial remaining battery power information Q_{INI}, which facilitates the calculation of battery power Q₂.

As described above, the remaining mileage is recalculated periodically each time the electric vehicle has traveled or been driven a second predetermined distance. In an embodiment, this distance can be a distance threshold represented by S_{TH}.

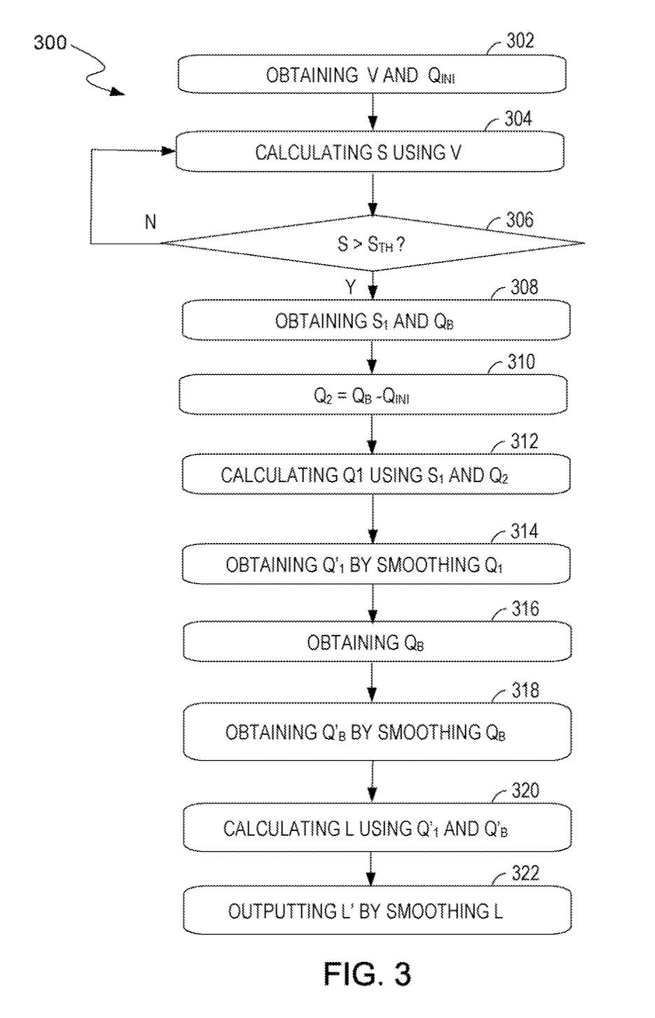

FIG. 3 illustrates a flowchart of a process 300 for calculating remaining mileage of an electric vehicle, in accordance with an embodiment of the present disclosure. Although specific steps are disclosed and shown by FIG. 3, such steps are examples, and the embodiments disclosed by the present disclosure is well suited to performing various other steps or variations of the steps recited in FIG. 3.

At step 302, the mileage device 102 obtains a velocity V from sensor 108 and an initial remaining battery power Q_{INI} from BMS 110. At step 304, the integral calculator 210 calculates the current driving distance S based upon the velocity V by using equation (3) described above. At step 306, the comparator 208 compares the current driving distance S₁ calculated by integral calculator 210, with a distance threshold S_{TH}. If the current driving distance S is less than the distance threshold S_{TH}, the flowchart proceeds back to step 304. If the current driving distance S is greater than the distance threshold S_{TH}, the comparator 208 outputs a first distance S₁ that equals the current driving distance S.

At step 308, the first calculator 204 receives the first distance S₁ and informs the second calculator 206. Second calculator 206 is then able to calculate the battery power Q₂ based upon the initial remaining battery power information Q_{INI} and the power balance Q_{B} of the electric vehicle. At step 310, the second calculator 206 calculates the battery power Q₂ by calculating the difference between the initial remaining battery power information Q_{INI} and the power balance Q_{B}. At step 312, the first calculator 204 receives the first distance S₁ from comparator 208 and the battery power Q₂ from second calculator 206. The battery power Q₂ represents the power that the electric vehicle has consumed while traveling or being driven the first distance S₁. First calculator 204 may then calculate the battery power Q₁ using equation (4) as described above.

At step 314, the filter 104 smoothes the battery power Q₁ and outputs the filtered battery power Q₁ to the mileage calculator 106. At step 216, upon receiving the filtered battery power Q′₁, the mileage calculator 106 instructs the filter 104 to obtain a power balance Q_{B} of the electric vehicle from the BMS 110. At step 318, the filter 104 smoothes the power balance Q_{B} and outputs a filtered power balance Q′_{B} to the mileage calculator 106.

At step 320, the mileage calculator 106 generates an estimated remaining mileage L based on the filtered battery power Q′₁, the filtered power balance Q′_{B} and the first predetermined distance D using equation (2), discussed above. At step 322, the filter 104 then smoothes the estimated remaining mileage L and outputs the remaining mileage L′ of the electric vehicle.

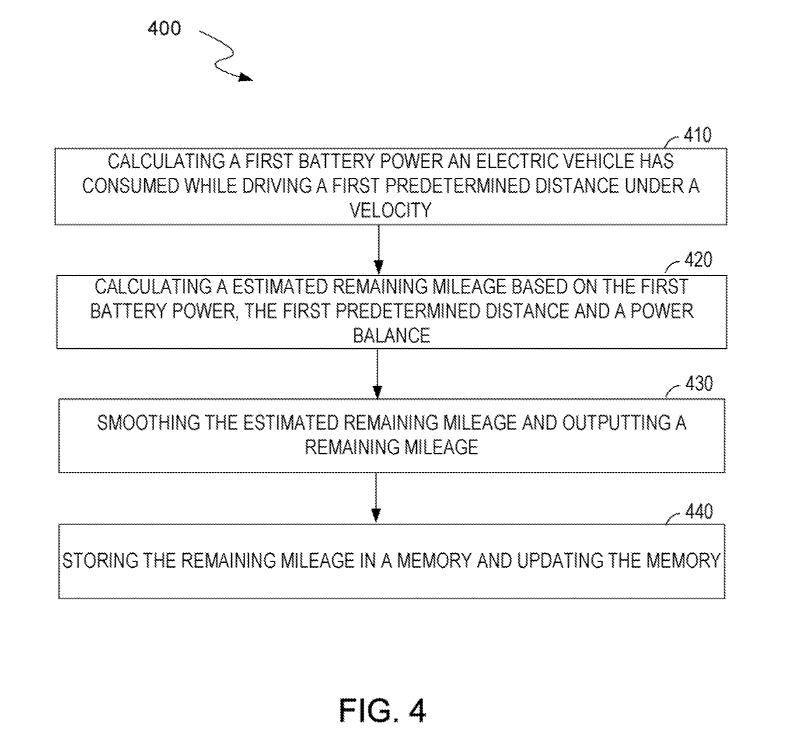

FIG. 4 illustrates a process depicting a method 400 for calculating remaining mileage of an electric vehicle, in accordance with an embodiment of the present disclosure. Although specific steps are disclosed and shown by FIG. 4, such steps are examples, and the embodiments disclosed by the present disclosure is well suited to performing various other steps or variations of the steps recited in FIG. 4.

At step 410, a battery power Q₁ that an electric vehicle has consumed by traveling or being driven a first predetermined distance D is calculated by estimation calculator 120. The estimation calculator 120 calculates the battery power Q₁ based on the velocity V and the initial remaining battery power Q_{INI} of the electric vehicle. More specifically, a current driving distance S is calculated by an integral calculator based on the velocity V. The current driving distance S is then compared with a distance threshold S_{TH} by a comparator 208. The comparator 208 outputs a first distance S₁ that equals the current driving distance S when the current driving distance S is greater than the distance threshold S_{TH}. The measurement of battery power Q₁ is provided by the first calculator 204 based on a first distance S₁ and a battery power Q₂ which the electric vehicle has consumed while driving the first distance S₁. The battery power Q₂ is calculated by the second calculator 206 based on the initial remaining battery power Q_{INI} and a power balance Q_{B} of the electric vehicle after the first calculator 204 receives the first distance S₁ and instructs the second calculator 206 to calculate the battery power Q₂.

At step 420, an estimated remaining mileage L is calculated by the mileage calculator 106 based on the battery power Q₁, the first predetermined distance and the power balance Q_{B} of the electric vehicle. The estimated remaining mileage L can be calculated using equation (2), described above.

At step 430, the estimated remaining mileage L is smoothed by the filter 104 in order to output the remaining mileage L′ of the electric vehicle. In an embodiment, the remaining mileage L′ is calculated by filter 104 using equation (1). The remaining mileage may then be stored by memory 122. As described above, the remaining mileage is recalculated periodically, each time the electric vehicle has traveled or been driven a second predetermined distance. The memory 122 can be updated accordingly at each periodic interval.

Embodiments of the methods described herein may be implemented using a processor and/or other programmable device. To that end, the methods described herein may be implemented on a tangible computer readable medium having instructions stored thereon that when executed the processor and/or other programmable device perform the methods. The storage medium may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

Unless specifically stated otherwise, as apparent from the preceding discussions, it is appreciated that throughout the specification discussions utilizing terms such as “operations,” “processing,” “computing,” “calculating,” “determining,” or the like, refer to the action and/or processes of a computer or computing system, or similar electronic computing device or apparatus, that manipulate and/or transform data represented as physical, such as electronic, quantities within the computing system's registers and/or memories into other data similarly represented as physical quantities within the computing system's memories, registers or other such information storage, transmission or display devices.

“Circuitry”, as used in any embodiment herein, may comprise, for example, singly or in any combination, hardwired circuitry, programmable circuitry, state machine circuitry, and/or firmware that stores instructions executed by programmable circuitry.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

We claim:

1. A device for calculating mileage comprising:
an estimation calculator configured for determining a first battery power consumed over a first predetermined distance, wherein the first battery power is determined based on a velocity and an initial remaining battery power;
a mileage calculator, coupled to the estimation calculator, configured for determining an estimated remaining mileage based on the first battery power, the first predetermined distance and a power balance; and
a filter, coupled to the estimation calculator and the mileage calculator, configured for smoothing the estimated remaining mileage and for outputting a smoothed estimated remaining mileage.

2. The device of claim 1, wherein the filter is configured to smooth the first battery power, and provide a smoothed first battery power to the mileage calculator prior to the mileage calculator determining the estimated remaining mileage.

3. The device of claim 1, wherein the filter is configured to smooth the power balance, and provide a smoothed power balance to the mileage calculator prior to the mileage calculator determining the estimated remaining mileage.

4. The device of claim 1, wherein the estimation calculator comprises:
an integral calculator configured for calculating a current driving distance based on the velocity;
a comparator, coupled to the integral calculator, configured for periodically comparing the current driving distance with a distance threshold and outputting a first distance that equals the current driving distance if the current driving distance is greater than the distance threshold; and
a first calculator, coupled to the comparator, configured for determining the first battery power based on the first distance and a second battery power consumed over said first distance.

5. The device of claim 4, wherein the estimation calculator further comprises:
a second calculator, coupled to the first calculator, configured for calculating the second battery power based on the initial remaining battery power and the power balance.

6. The device of claim 4, wherein the estimation calculator further comprises:
a memory configured for storing the initial remaining battery power.

7. The device of claim 1, wherein the power balance represents a current instantaneous battery power after travelling a second predetermined distance.

8. The device of claim 7, further comprising:
a memory configured for storing the remaining mileage, wherein the remaining mileage is recalculated and updated in the memory each time the second predetermined distance is reached.

9. An electric controller, comprising
a sensor configured for obtaining a velocity;
a battery gauge configured for obtaining an initial remaining battery power;
a mileage device configured for determining a remaining mileage based on the velocity and the initial remaining battery power; and
a display unit configured for displaying the remaining mileage.

10. The electric controller of claim 9, wherein the mileage device comprises:
an estimation calculator configured for determining a first battery power consumed over a first predetermined distance, wherein the first battery power is determined based on the velocity and the initial remaining battery power; a mileage calculator, coupled to the estimation calculator, configured for determining an estimated remaining mileage based on the first battery power, the first predetermined distance and a power balance; and
a filter, coupled to the estimation calculator and the mileage calculator, configured for smoothing the estimated remaining mileage and outputting a smoothed estimated remaining mileage.

11. The electric controller of claim 10, wherein the filter comprises a first order filter.

12. The electric controller of claim 10, wherein the filter is configured to smooth the first battery power prior to the mileage calculator determining the estimated remaining mileage.

13. The electric controller of claim 10, wherein the filter is configured to smooth the power balance prior to the mileage calculator determining the estimated remaining mileage.

14. The electric controller of claim 10, wherein the power balance represents a current instantaneous battery power after travelling a second predetermined distance.

15. The electric controller of claim 14, wherein the mileage device comprises a memory configured for storing the remaining mileage, and wherein said remaining mileage is recalculated and updated in the memory each time the second predetermined distance is reached.

16. The electric controller of claim 15, wherein the display unit is configured for reading the memory, retrieving the remaining mileage, and displaying the remaining mileage at a predetermined frequency.

17. The electric controller of claim 10, wherein the estimation calculator comprises:
an integral calculator configured for calculating a current driving distance based on the velocity;
a comparator, coupled to the integral calculator, configured for periodically comparing the current driving distance with a distance threshold and outputting a first distance that equals the current driving distance if the current driving distance is greater than the distance threshold; and
a first calculator, coupled to the comparator, configured for determining the first battery power based on the first distance and a second battery power consumed over the first distance.

18. The electric controller of claim 10, wherein the estimation calculator further comprises:
a memory configured for storing the initial remaining battery power.

19. A method for calculating remaining mileage, comprising:
calculating, by an estimation calculator, a first battery power consumed over a first predetermined distance, wherein the first battery power is determined based on a velocity and a remaining battery power;
calculating, by a mileage calculator, an estimated remaining mileage based on the first battery power, the first predetermined distance and a power balance; and
smoothing, by a filter, the estimated remaining mileage and outputting the remaining mileage representing the smoothed estimated remaining mileage.

20. The method of claim 19, further comprising:
calculating a current driving distance based on the velocity;
periodically comparing the current driving distance with a distance threshold and outputting a first distance that equals the current driving distance if the current driving distance is greater than said distance threshold; and
determining the first battery power based on the first distance and a second battery power consumed over the first distance.

21. The method of claim 20, further comprising:
calculating the second battery power based on the initial remaining battery power and the power balance.

22. The method of claim 19, wherein the power balance represents a current instantaneous battery power after travelling a second predetermined distance.

23. The method of claim 22, further comprising:
storing the remaining mileage in a memory, wherein the remaining mileage is recalculated and updated in the memory each time the second predetermined distance is reached.
